(19) United States
(12) Patent Application Publication
(10) Pub. No.: US 2011/0299376 A1
(43) Pub. Date: Dec. 8, 2011

(54) FORMING A VISIBLE LABEL ON AN OPTICAL DISC

(75) Inventors: Donald B. Ouchida, Corvallis, OR (US); Timothy Wagner, Corvallis, OR (US)

(73) Assignee: HEWLETT-PACKARD DEVELOPMENT COMPANY, L.P., Houston, TX (US)

(21) Appl. No.: 13/202,580

(22) PCT Filed: Mar. 4, 2009
(86) PCT No.: PCT/US2009/036037

§ 371 Date: Aug. 21, 2011

(51) Int. Cl. G11B 7/00

(52) U.S. Cl. 369/100; G9B/7

(57) ABSTRACT

A system, method, and medium for forming a visible label on an optical disc. Label data for a label track of the disc is received into a buffer of a disc drive. The label data is analyzed to identify the label track. A surface contour of the disc is mapped only near the label track. Focus actuator signals for the label track are derived using the surface contour. The label track is marked, with a laser of the disc drive, according to the label data while the laser is focusing the focus actuator signals.

### BACKGROUND

Some optical disc drives are capable of generating a visible label on an optical disc removably inserted in the disc drive. Optical discs for use with such drives typically have, in addition to a mechanism which allows digital data to be stored on the disc, an internal or external labeling surface that includes a material whose color, darkness, or both can be changed, with the controlled application of a laser beam thereto, in order to form visible markings at the positions on the labeling surface at which the laser beam is applied. The visible markings that constitute the label can collectively form text, graphics, and photographic images on the optical disc. Such a labeling mechanism advantageously avoids the need for additional equipment such as a silk-screener, or for the inconvenience of having to print and attach a physical label to the disc. Many users would also like the visible markings to form a label of high image quality and be produced as quickly as possible.

### BRIEF DESCRIPTION OF THE DRAWINGS

The features of the present invention and the manner of attaining them, and the invention itself, will be best understood by reference to the following detailed description of embodiments of the invention, taken in conjunction with the accompanying drawings, wherein:

FIG. 1 is a schematic representation of an optical disc in accordance with an embodiment of the present invention that illustrates features of a labeling surface;

FIG. 2 is a schematic representation of an optical disc drive in accordance with an embodiment of the present invention that is capable of forming a visible label on the optical disc of FIG. 1 using a laser;

FIG. 3 is a schematic representation of label data in accordance with an embodiment of the present invention that is indicative of visible markings to be formed on the labeling surface of the optical disc of FIG. 1;

FIG. 4 is a flowchart in accordance with an embodiment of the present invention of a method of forming a visible label on the optical disc of FIG. 1; and

FIG. 5 is a lower-level flowchart in accordance with an embodiment of the present invention of a method of determining whether there are more label tracks to map of FIG. 4.

### DETAILED DESCRIPTION

Referring now to the drawings, there are illustrated embodiments of the present invention that form a visible label of a high image quality on an optical disc inserted in a disc drive using a laser in the disc drive. The label is formed by the laser controllably making visible marks on label tracks of a label surface of the optical disc, as instructed by label data received by the disc drive.

To achieve a high level of image quality, the size of the spots or marks formed by the laser on the optical disc should be consistent. The size of these spots is determined at least in part by the degree of focus of the laser beam, generated by the laser, on the label track on which the marks are being formed. The optical drive uses a focus actuator mechanism to properly position the laser to generate a laser beam having the intended degree of focus at the label surface. Properly positioning the laser involves operating the focus actuator to place the laser optics at a desired distance relative to the labeling surface.

However, an optical disc may not be perfectly flat; instead it may be warped in some manner. Furthermore, the disc may be tilted when it is inserted into the disc drive. As a result, in order for high quality imaging to be maintained under such conditions, the location at which the laser is positioned by the focus actuator in order to maintain the desired distance relative to the labeling surface can vary with both the radial position of a label track from the hub of the optical disc, and with the angular position around a label track, according to a “surface contour” of the optical disc in the disc drive that results from the warp and the tilt.

The characteristics of the label surface, and the desired degree of focus, require that the surface contour of the disc, as it is installed in the disc drive, be “mapped”, or characterized, before the laser forms the marks. The time to perform this surface contour mapping operation adds to the total amount of time it takes to label the disc. Typically, the surface contour is mapped for the entire labelable surface of the disc, as marks can be made anywhere on this surface. However, there are often portions of the labelable surface on which the user chooses not to make marks. For example, the marks that constitute the text and/or image(s) with which the user wishes to label the disc may occupy only certain label tracks, or angular portions thereof, on the labelable surface. Thus it would be superfluous to map the surface contour of those tracks on which labeling marks would not be formed. Not mapping those unused areas can save time in the mapping process, and thus reduce the overall time it takes to form a label on the disc. Knowing the areas of the labelable surface that are desired to be marked before the mapping process is performed gives insight as to which regions of the labelable surface should be mapped.

As will be described in greater detail subsequently, embodiments of the present invention advantageously reduce the time it takes to perform the surface contour mapping operation, and thus reduce the total time it takes to label the disc, by mapping the surface contour only at some or all of those label tracks for which the label data indicates that marks are to be made.

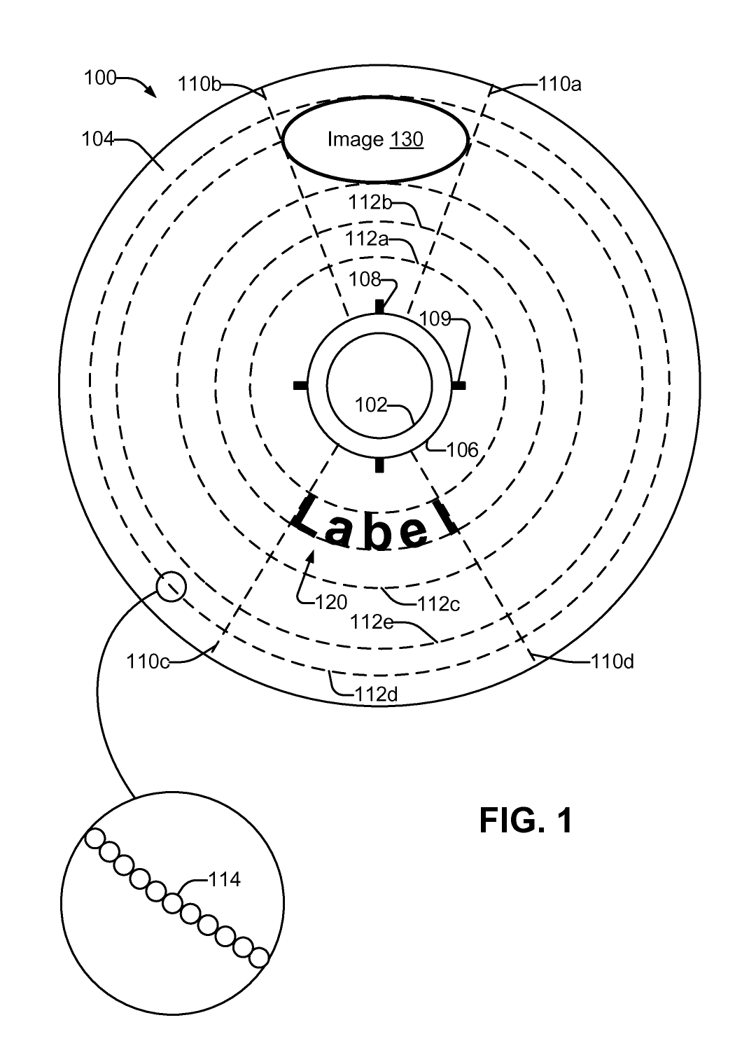

Considering now one embodiment of an optical disc, and with reference to FIG. 1, the optical disc 100 may be a CD (compact disc), DVD (digital versatile disc), or other forms of optical discs capable of forming visible markings on or within the disc in response to the application of electromagnetic energy, such as from a laser, to the disc. This includes discs in CD-R, CD-RW, DVD+R, DVD-R, DVD+RW, DVD-RW, and DVD-ROM formats, and the like. Such discs also typically store digital data that may represent, for example, photographs, videos, music, computer programs, and other various types of information or data. In some discs the data is prefabricated, while in other discs the data may be written to the disc using an optical disc drive. Digital data stored on a disc can be read from the disc using an optical disc drive.

Various physical and chemical structures may be used to provide the optical disc with the capability of forming the visible markings in response to the application of a proper amount of electromagnetic energy to the disc. In one embodiment, a labeling layer or coating is applied to at least a portion of a surface of the disc. In one embodiment, the layer is applied to the disc surface on the opposite side of the disc from the surface through which laser energy is impinged to read or write the digital data. In one embodiment, the labeling coating is a laser-sensitive layer that has thermochromic and/or photochromic materials that can be activated at desired locations by the application of laser energy to the desired locations. In some embodiments the materials may be sensitive only to energy within a particular band of frequencies, either visible or invisible. In one embodiment, these frequencies may be in the infrared or near-infrared region. When and where activated, the materials form visible markings having a particular color, darkness, and/or contrast relative to unmarked materials. A coating may enable the generation of markings that are all of a single color, or of multiple colors. The coating may be applied continuously to the surface, or to discrete locations on the surface.

Optical disc 100 includes a central hub 102 which mounts and positions the disc 100 in an optical disc drive for data reading and writing, and for marking a label surface 104 of the disc 100. The label surface 104 typically extends on the disc 100 from an inner radius to an outer radius. In some embodiments, the inner and outer radii of the label surface 104 do not extend completely to the inner and outer radii of the disc 100. In one embodiment, a ring of disc control features 106 is disposed closer to the hub 102 than the inner radius. The disc control features 106 are usable by the disc drive to determine and control the speed of rotation of the disc 100, and the angular orientation or angular position of the disc 100 in the disc drive. In one embodiment, the disc control features 106 include an index mark 108 usable to determine a reference position—for example, 0 degrees—for the angular position of the disc 100 in the drive. For example, the index mark 108 may be defined as an angular position of 0 degrees, while angular position 110a may be defined as an angular position of approximately 20 degrees in a clockwise direction as illustrated. In one embodiment, the disc control features 106 also include spokes 109. For clarity only three spokes 109 are illustrated, but it is understood that the disc control features 106 may include a large number of spokes such as, for example, 360 spokes. In some embodiments, where the spokes are equally spaced around the ring 106, each of the 360 spokes would represent 1 degree of angular displacement. The disc drive can, in one embodiment, sense the index mark 108 and count the spokes 109 as the disc 100 is rotated, and thus can determine the angular position of the disc 100 relative to the laser or other drive components.

The laser beam generated by the optical disc drive can be directed onto one of a plurality of label tracks 112 that are concentrically (i.e. annularly) or spirally defined between the inner and outer radii of the label surface 104. In one embodiment, the distance between the inner and outer radii is 1.374 inches.

Where the tracks are concentric, each label track 112 has a corresponding radial position from the hub 102. Where the tracks are spiral, the spiral is generally composed of spiral segments of 360 degrees, where the two ends of a particular track are one track spacing apart in the radial direction. While FIG. 1 illustrates circular tracks, it is understood that the invention also encompasses the use of spiral tracks.

While only exemplary tracks 112a-e are illustrated, it is to be understood that a large number of different radial positions 112 exist on the disc 100. In one embodiment, where the label surface 104 is a continuous material, the label tracks 112 are not inherent to the optical disc 100, but rather are defined by the disc labeling system. The total number of tracks on the disc 100 may be determined, at least in part, by the imaging characteristics of the drive, disc media, and settings chosen directly or indirectly by the user. In one embodiment, the label surface 104 has approximately 1,170 tracks, with a track density of approximately 850 tracks/inch (tpi) in the radial direction. In other embodiments, the track density can range from about 400 tpi to 2,000 tpi.

Along each track 112 are a number of individual markable locations or positions 114. While the exemplary markable locations 114 are illustrated as circular, within a given track 112 they may alternatively be oblong, continuous (instead of discrete), or have other shapes or characteristics. An individual markable location 114 can be marked by positioning the laser adjacent to the track of the desired markable location 114, properly focusing the laser beam on the label surface 104, and synchronizing the application of laser energy to the proper angular position of the markable location 114 on the disc 100 during disc rotation. In some embodiments, the concentric tracks 112 of markable locations 114 abut one another on the label surface 104, and thus the radial positions of adjacent tracks 112 may be generally determined by the dimensions of the markable locations 114, particularly in the radial direction. Marks may be formed on selected ones of the locations 114 in a pattern that collectively forms the label for the disc 100. For example, a first group of marks 114 forms a textual image 120 of the word “Label” on the disc 100, while a second group of marks 114 forms a graphical image 130 such as, for example, a photographic image.

Images 120,130 each encompass a radial span on the label surface 104. Text image 120 radially spans the tracks between track 112a and track 112b, while graphical image 130 radially spans the tracks between track 112c and track 112d. In these exemplary images 120, 130, every track between tracks 112a and 112b, and between tracks 112c and 112d, requires that at least one location 114 be marked in order to form the image. However, it is noted that other tracks on the label surface 104 require no marks at any locations 114 to form images 120, 130. For example, no marks are formed on the tracks from the inner radius to track 112a; the tracks between tracks 112b and 112c; and the tracks between track 112d and the outer radius.

Furthermore, for each track 112 which includes at least one mark, the marks on the track 112 collectively occupy at least one angular span. For example, at track 112e, graphical image 130 occupies the angular span between angular positions 110a and 110b. Since graphical image 130 is elliptically shaped, the angular span occupied at tracks 112c and 112d is much narrower, however. Similarly, at track 112a, textual image 120 occupies an angular span between angular positions 110c and 110d.

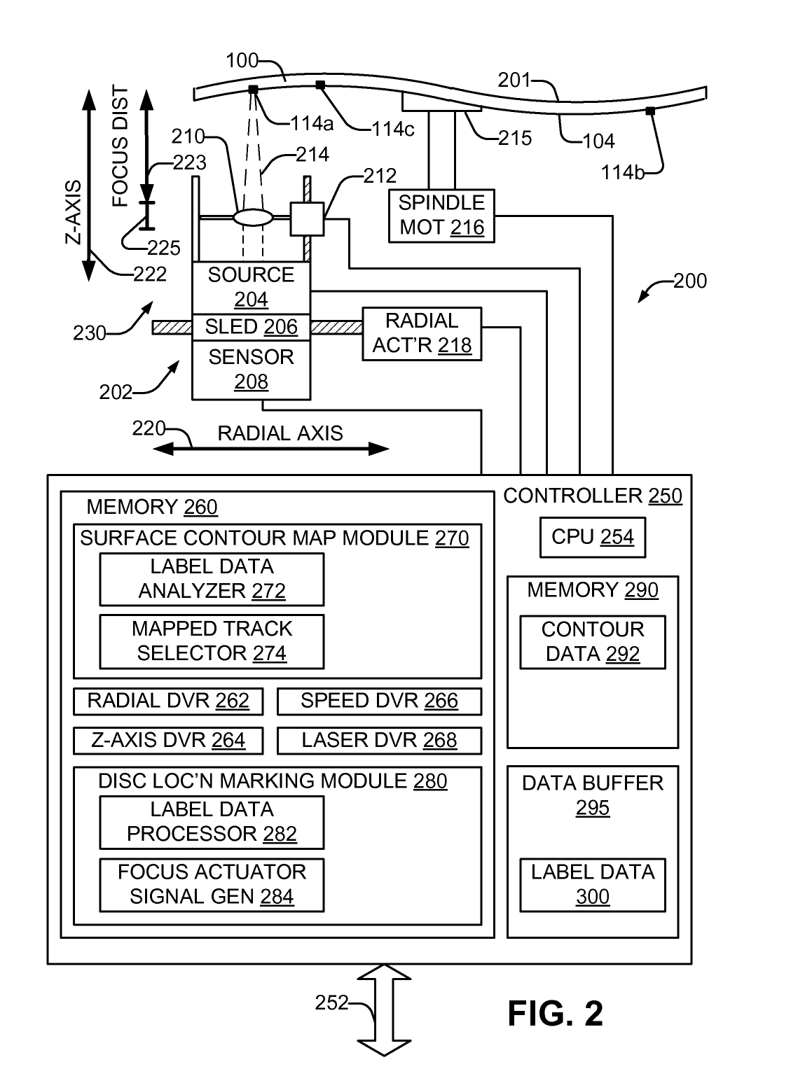

Considering now an embodiment of an optical disc drive usable to label the optical disc 100, and with reference to FIG. 2, an optical disc drive (ODD) 200 includes an optical pick-up unit assembly (OPU) 202. The OPU 202 may include an electromagnetic energy source 204, which may be a laser source, and an objective lens or focus optics 210. The OPU 202 may also include a sled 206, a sensor 208, and a focus actuator 212. The focus actuator 212 is configured to respond to an input signal, which may be voltage or current, to cause the optics 210 to move the focal point of the electromagnetic energy beam 214 generated by source 204. The electromagnetic energy beam 214 may be a laser beam. Taken together, the laser source 204 and the focus optics 210 constitute a laser 230.

In an exemplary embodiment, a spindle motor 216 is configured to spin or rotate the optical disc 100 substantially circularly. The optical disc 100 is removably mounted to a spindle 215 by mating the hub 102 of the disc 100 with the spindle 215. When labeling the label surface 104, the disc 100 is mounted such that the label surface 104 faces the laser 230. Where the disc 100 is such that the label surface 104 is on (or is accessed from or through) the opposite side of the disc 100 from a data surface 201 of the disc 100, the disc 100 may be mounted in the drive 200 upside-down from the orientation used when reading digital data from, or writing digital data to, the disc 100.

A radial actuator 218 may be arranged to move the laser 230, which is mounted on the sled 206, to different radial positions along a radial axis 220 with respect to the center of the disc 100. The radial actuator 218 positions the laser adjacent to particular label tracks 112 on the label surface 104 such as, for example, tracks 112a-e. The operation of the spindle motor 216 and radial actuator 218 can be coordinated to move the label surface 104 of the disc 100 and the laser 230 relative to each other to permit the laser 230 to create an image on the disc 100 by forming marks on selected ones of the markable locations 114 on the label surface 104. In some embodiments the radial actuator 218 may include a coarse adjustment mechanism which moves the sled 206 along the radial axis 220, and a fine adjustment mechanism which moves the laser 230 with respect to the sled 206.

In an exemplary embodiment, the focus optics 210 may mounted on lens supports and configured to travel along a z-axis 222 which is generally perpendicular to the label surface 104 of the disc 100. In an exemplary embodiment, the focus actuator 212 adjusts the focal point of the laser beam 214 by moving the focus optics 210 toward or away from the label surface 104 of the disc 100. In an exemplary embodiment, the focus actuator 212 is controlled during a disc marking or labeling operation to place the focus optics 210 at a desired position so that markings of a desired darkness and/or color, and size can be formed on the markable locations 114 of the label surface 104.

Sensor 208 provides signal data indicative of the degree of focus of the laser beam 214 on label surface 104. A portion of the laser energy applied to the label surface 104 can be reflected back through the optics 210 to the sensor 208. In one embodiment, sensor 208 has four individual sensor quadrants, A, B, C and D, that collectively provide a SUM signal. Quadrants A, B, C, and D may be configured to measure reflected light independent of one another. In particular, voltage is generated by the quadrants A, B, C and D in response to reflected light. When the sum of the measured voltage of the quadrants A, B, C and D are at a relative maximum, it is an indication that the focus optics 210 are positioned along the z-axis 222 in a position that places the laser beam 214 at an in-focus position on the label surface 104. In other embodiments, quadrant outputs of sensor 208 may be added or subtracted in other combinations to provide different signals, such as a focus error signal (FES).

In an exemplary embodiment, the disc drive 200 includes a controller 250. The controller 250 may be connected via a computing device interface 252 to a computing device (not shown) or other data source external to the disc drive 200. The controller 250 may be implemented, in some embodiments, using hardware, software, firmware, or a combination of these technologies. Subsystems and modules, or portions thereof, of the controller 250 may be implemented using dedicated hardware, or a combination of dedicated hardware along with a computer or microprocessor controlled by firmware or software. Dedicated hardware may include discrete or integrated analog circuitry and digital circuitry such as programmable logic device and state machines. Firmware or software may define a sequence of logic operations and may be organized as modules, functions, or objects of a computer program. Firmware or software modules may be executed by at least one CPU 254 for processing computer/processor-executable instructions from various components stored in a computer-readable medium, such as memory 260. Memory 260 may be any type of computer-readable medium for use by or in connection with any computer-related system or method. Memory 260 is typically non-volatile, and may be read-only memory (ROM).

In one embodiment, the controller 250 may be implemented on one or more printed circuit boards in the disc drive 200. In other embodiments, at least a portion of the controller 250 may be located external to the disc drive 200. The disc drive 200 may be included in a computer system, such as a personal computer, may be used in a stand-alone audio or video device, may be used as a peripheral component in an audio or video system, or may be used in a stand-alone disc media labeling device or accessory. Other configurations are also contemplated.

In one embodiment, the controller 250 generates control signals for the spindle motor 216, radial actuator 218, focus actuator 212, and electromagnetic energy source 204. The controller 250 also reads data, where appropriate, from these components, including degree-of-focus data from sensor 208.

In some embodiments, the controller 250 includes a radial position driver 262, a z-axis position driver 264, a disc rotation speed driver 266, and a laser driver 268. In an exemplary embodiment, the drivers may be firmware and/or software components which may be stored in memory 260 and executable on CPU 254. The drivers may cause the controller 250 to selectively generate digital or analog control or data signals, and read analog or digital data signals.

In an exemplary embodiment, the disc rotation speed driver 266 drives spindle motor 216 to control a rotational speed of optical disc 100 via the spindle 215. The disc rotation speed driver 266 operates in conjunction with the radial position driver 262 which drives the radial actuator 216 to control at least coarse radial positioning of OPU assembly 202 with respect to disc 100. In disc surface contour mapping operations, and disc location marking operations, the sled 206 of OPU 202, including laser 230, is moved along the radial axis 220 to various tracks 112 of optical disc 100. In some embodiments, for a given radial position of the laser 230 the disc rotation speed driver 266 rotates the disc 100, for a given track 112, at a faster speed during disc surface contour mapping operations than during disc location marking operations.

In an exemplary embodiment, the laser driver 268 controls the various components of the OPU 202. The laser driver 268 controls the firing of the laser source 204, and controls the intensity of the laser beam 214 generated by the laser source 204. In some embodiments, a lower intensity laser beam 214 is generated during disc surface contour mapping operations, while a higher intensity laser beam 214 is generated during disc location marking operations.

In an exemplary embodiment, the z-axis position driver 264 controls the focus actuator 212 in order to adjust the position of the focus optics 210 along the z-axis 222.

In an exemplary embodiment, the controller 250 further includes a disc surface contour mapping module 270, and a disc location marking module 280.

The disc surface contour mapping module 270 characterizes the contour of the label surface 104 of the disc 100 by determining the position of the laser optics 210 that focuses the laser beam 214 to a desired degree of focus on one or more locations 114 of a desired track 112 on the label surface 104 of the disc 100. The focus is generally maintained within a few microns of the label surface 104 of the disc 100, or the various markings may exhibit undesirable darkness or color variations due to differences in the absorbed laser energy at the differing locations 114 on the label surface 104 of the disc 100.

Disc surface contour mapping may be performed for a variety of reasons when labeling on the label surface. While a conventional disc drive is capable of maintaining the laser in an in-focus position in real-time during reading data from, or writing data to, the data surface 201 of the disc 100 regardless of surface contour, it cannot do so when forming a visible label to the tracks 112 of label surface 104 for a variety of reasons. One reason is that the quality of the signal detected by the sensor 208 is inadequate. This occurs if the label surface 104, as is typical, is not as reflective as the data surface 201. In such a situation, it is difficult or impossible to extract a reliable signal in real-time. In addition, the label surface 104 is typically not as smooth as the data surface 201. As a result, the signal from the sensor 208 may need to be averaged to eliminate the noise, which prevents real-time focusing during marking. Another reason why disc surface contour mapping is performed is that the desired degree of focus for a marking operation does not correspond to an in-focus position of the laser, but rather to a defocused position of the laser. This defocusing may be accomplished, in one embodiment, by applying a focus offset signal to the focus actuator 212 that offsets the optics 210 a focus offset distance 225 along the z-axis 222 from its actual in-focus distance 223. One reason for defocusing the laser is to produce a larger spot size, and thus a larger mark, than would be produced with an in-focus laser beam. However, when the laser is defocused to the desired degree for marking, the sensor 208 will typically be operating outside of its usable signal range for providing real-time focus control.

Thus because of these factors, the disc surface contour is mapped before the laser forms the marks. However, because disc contour mapping is an additional, sequential operation, it increases the total time to label the disc.

With regard to the contour of the label surface 104, disc 100 is illustrated in FIG. 2 not as being flat, but as having a surface contour that varies with radial and angular position (the contour variation is exaggerated for clarity of illustration). The laser beam 214 is illustrated as focused at location 114a on label surface 104. Location 114a corresponds to a certain track 112, and focus actuator 212 places optics 210 in the position illustrated so that the laser beam 214 is focused at location 114a. However, when disc 100 is rotated so that location 114b, which corresponds to the same track 112 as location 114a, is positioned adjacent the laser 230, focus actuator 212 moves optics 210 to a different position along the z-axis 222 in order to make the laser beam focus or converge at location 114b. This is due to the variation in the surface contour of the disc 100 which causes location 114b to be closer to the laser source 204 along z-axis 222 than is location 114a.

Similarly, consider location 114c on label surface 104, which has the same angular position as location 114a, but is on a different track 112. When the laser source 204 is moved along the radial axis 220 so that the laser beam 214 impinges location 114c instead of 114a, focus actuator 212 moves the optics 210 to a different position along the z-axis 222 in order to make the laser beam focus or converge at location 114c. This is due to the variation in the surface contour of the disc 100 which causes location 114c to be farther from the laser source 204 along z-axis 222 than is location 114a.

In some embodiments, the disc surface contour mapping module 270 operates the laser 230 and the focus actuator 212 to apply the laser beam 214 to the label surface 104, but at a level and for a time that is insufficient to form any marks on the surface 104. The module 270 measures signals, provided by the sensor 208, that are indicative of the degree of focus of the laser beam 214 on a given location 114 for a given position of the focus actuator 212 and the optics 210 along the z-axis 222, and may in some embodiments observe how the signals change as the focus actuator 212 moves the optics 210 to one or more different positions along the z-axis 222. During the disc surface contour mapping operation, the disc surface contour mapping module 270 may continually operate the radial actuator and spindle motor to measure degree of focus at many locations 114 corresponding to different track radii and angular positions of the disc label surface 104. In some embodiments, the disc surface contour mapping module 270 rotates the disc 100 at a faster speed for a given track 112 than does the disc location marking module 280 that will be subsequently described.

Embodiments of the present invention advantageously reduce the time to perform the surface contour mapping operation, and thus reduce the total time it takes to label the disc. One manner in which this time reduction is achieved is by the surface contour mapping module 270 mapping the surface contour only at those tracks 112 on which at least one location 114 is to be marked. The surface contour of the disc 100 is not mapped at those tracks 112 on which no locations 114 are to be marked, thus saving the time that would otherwise be expended to map the contour at those tracks 112 on which no locations 114 are to be marked. In some embodiments, additional time reduction is achieved by mapping the surface contour at fewer than all of those tracks 112 on which at least one location 114 is to be marked, instead using the contour determined for a mapped track when marking nearby unmapped tracks.

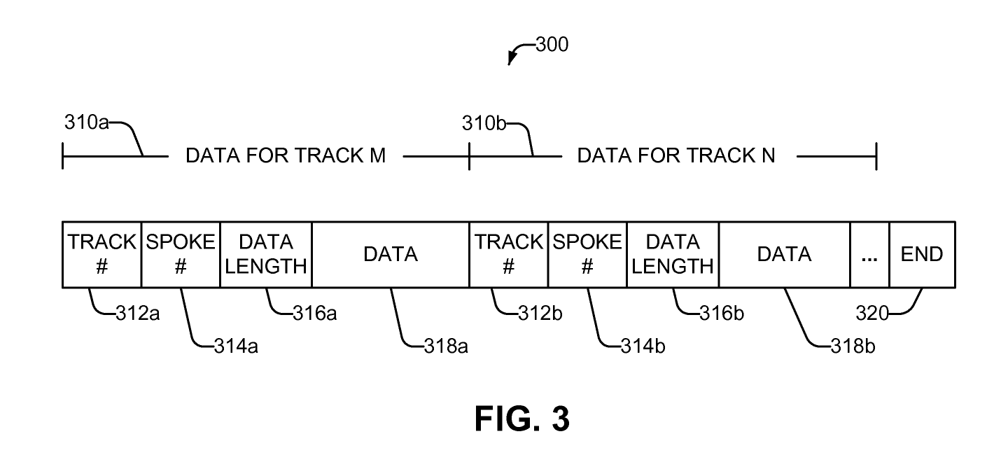

Determining which tracks 112 have locations 114 to be marked is performed by analyzing label data 300. A data buffer 295 of the disc drive 200 is configured to receive the label data 300 from a source external to the disc drive 200. The label data may be received by the drive 200 over device interface 252. The format of label data 300 will be discussed subsequently in greater detail with reference to FIG. 3. Data buffer 295 may be part of controller 250, or alternatively may be separate from it in whole or in part.

Data buffer 295 is a read-write (RAM) memory, and may be organized as a logically circular buffer of a particular size. Label data 300 may continue to be received into data buffer 295 while controller 250 is performing surface contour mapping operations, disc location marking operations, or both. In some embodiments, the data buffer 295 may be sized to hold the label data 300 for the entire label, or for a substantial portion of the label. A set of data buffer pointers may be utilized to keep track of conditions such as whether label data exists in the buffer, how much room remains in the buffer, whether the buffer is full, and the like. In some embodiments, label data 300 for a track 112 is received into the data buffer significantly faster than a track 112 can be mapped by surface contour mapping module 270 or marked by disc location marking module 280.

A label data analyzer submodule 272 analyzes the label data 300 in the data buffer 295 in order to identify the label track or tracks 112 to which the label data 300 corresponds. In some embodiments, the label data analyzer submodule 272 may further analyze the label data 300 to identify the angular positions 110 of the label track or tracks 112 to which the label data 300 corresponds.

The surface contour mapping module 270 generates surface contour data 292 that characterizes the surface contour of label surface 104 of the disc 100 at, or near, the tracks 112 that correspond to the label data 300. The surface contour data 292 is stored in a read-write memory 290. In some embodiments, memory 290 may be part of memory 260 or data buffer 295. Data buffer 295 may be part of memory 260 in some embodiments. In some embodiments, memory 290, memory 260, and data buffer 295 may all be part of the same memory device.

In some embodiments, the disc surface contour may be mapped at all the label track or tracks 112 to which the label data 300 corresponds.

In other embodiments, the disc surface contour will be mapped at fewer than all the label track or tracks 112 to which the label data 300 corresponds. A mapped track selector module 274 determines, from the label track or tracks 112 identified by the label data analyzer submodule 272 as corresponding to the label data 300, the particular track or tracks 112 at which the disc surface contour will be mapped and surface contour data 292 generated. Since changes in surface contour of the disc typically occur relatively slowly, the surface contour data 292 for one track can be used for marking adjacent tracks located up to a predetermined radial distance from the mapped track, and still produce high image quality marks on those adjacent tracks. In one embodiment, the predetermined radial distance is 1 mm. In such an embodiment, for an exemplary track width of 0.03 mm, the surface contour determined for a particular mapped track could also be used for marking the 33 next tracks, thus saving time by not mapping the surface contour for those 33 tracks even where marks are to be made on some or all of those 33 tracks. In another embodiment, the predetermined radial distance is 2 mm.

Controller 250 also includes a disc location marking module 280. The disc location marking module 280 marks designated ones of the markable locations 114 on the disc 100, according to the label data 300 indicative of the image to be formed on the disc 100. In some embodiments, the disc location marking module 280 includes a label data processor submodule 282 that processes the label data 300 to determine the tracks 112, and that angular positions along the tracks 112, of the ones of the markable locations 114 designated to be marked by the laser beam 214. In some embodiments, the label data processor module 282 may also determine, for the designated locations 114 to be marked, the darkness and/or color of the mark. In some embodiments, the disc location marking module 280 includes a focus actuator signal generator submodule 284 that derives, using the surface contour data 292 generated by the mapping module 270, input signals for the focus actuator 212 that position the focus optics 210 at the proper focus position for the track 112 and the angular position 110 of each location 114 to be marked. As the sled 206 is positioned at a designated track 112, and as the disc 100 is rotated by the spindle motor 216 through different designated angular positions 110, the disc location marking module 280 applies to the focus actuator 212 the calculated focus actuator signals in sync with the rotation of the disc 100, and controls the laser 230 to generate the laser beam 214 form the desired mark on the designated locations 114. During operation, in some embodiments, the disc location marking module 280 rotates the disc 100 at a slower speed for a given track 112 than does the disc surface contour mapping module 270. In some embodiments, the difference in rotation speed occurs because the amount of laser energy that is applied to mark a location 114 is significantly greater than the amount of laser energy that is applied to generate a sufficient signal from sensor 208 for surface mapping. As a result, for a laser 230 of a given power, a slower speed of rotation is used during a marking operation to allow the laser beam 214 to dwell on the region of the particular location 114 long enough to produce the mark. In other words, the rotating speed during a marking operation is limited by the power of the laser 230. However, during a mapping operation, the rotating speed is not limited by the power of the laser 230. In many embodiments, the disc surface contour mapping operation can be performed at a disc rotating speed which is 10 to 20 times faster than the fastest rotation speed used during a disc marking operation.

Considering now in greater detail one embodiment of the label data 300 indicative of the visible markings to be formed on the labeling surface 104 of the optical disc 100, and with reference to FIG. 3, in one embodiment the device interface 252 is a SCSI interface, and the label data 300 is received by the disc drive 200 in the form of data embedded in SCSI print commands. The received label data 300 may include multiple data packets 310. Each data packet 310a,b contains data for a specific track 112. Data packets 310 may be received by the disc drive 200 as long as the data buffer 295 is not full. In one embodiment, each data packet 310 includes a track number 312, a spoke number 314, a data length 316, and a data block 318. The track number 312, spoke number 314, and data length 316 may be considered to form a header of the data packet 310. In one embodiment, data packets 310 are ordered in the buffer 300 by track number 312, from the inner radius to the outer radius of the label surface 104; such ordering typically occurs as a result of the order in which the data packets 310 are sent to the disc drive 200 over the device interface 252.

The track number 312 specifies the track 112 of the label surface to which the data block 318 of the data packed 310 pertains. The spoke number 314 specifies the angular position 110 of the first data element in the data block 318; in other words, the angular position 110 at which the data for the track 312 begins. The data length 316 specifies the length of the data block; in other words, how many data elements are contained in the data block. It is noted that the number of equally-sized marking locations 114 on a track 112 varies with the track number, as more markings can be made on a track near the outer radius than on a track near the inner radius of the label surface 104. The data block 318 contains the data elements for consecutive locations on the corresponding track number 312 beginning at the angular position 110 specified by the corresponding spoke number 314. The data block 318 may be in uncompressed or compressed form. In some embodiments, each data element is a binary value; for example, a value of “1” indicates that a mark is to be made at the corresponding location 114, while a value of “0” indicates that no mark is to be made at the corresponding location 114. In other embodiments, each data element may occupy multiple bits, and may specify a certain gray scale value and/or color.

Considering the images 120,130 of the label surface 104 as an example, assume that the track numbering is such that inner radius is track 0, track 112a is track 100, track 112b is track 150, track 112c is track 200, track 112d is track 300, and the outer radius is track 350. Also, assume that data buffer 295 is large enough to hold all the label data 300 for images 120,130. The first data packet 310 in the data buffer 295 would represent the data for track 100, and would be followed by data packets 310 representing tracks 101 through 150. The next data packet 310 in the data buffer 295 would represent the data for track 200, and would be followed by data packets 310 representing tracks 201 through 300. Following the data packet 310 for track 300, an end-of-data marker 320 could be received. Thus the disc surface contour mapping operation would map at least some tracks within these two groups of tracks 100 through 150 and 200 through 300, since markings would be made within these groups based on the data packets received. The label data 300 would not include any data packets 310 for any of track numbers 0 through 99, 151 through 199, or 301 through 350, because no portion of images 120,130 occupy those tracks. Thus the disc surface contour mapping operation would not map any of this group of tracks, since no markings would be made on any of them and no data packets are received for any of them.

The data packets 310 for tracks 101 through 150 correspond to textual image 120. Assume for purposes of illustration that spoke number 0 corresponds to the index mark 108, and that the numbering of spokes 109 proceeds in a clockwise manner from the index mark 108. Accordingly, assume that angular position 110a corresponds to spoke number 20; angular position 110d to spoke number 150; angular position 110c to spoke number 210; and angular position 110d to spoke number 340.

Thus the data packet 310 for track 112a (which is track number 100) has a spoke number 314 value of 150 (which is angular position 110d). This data packet 310 also has a data length 316 value corresponding to the amount of data utilized to mark only a portion of track number 100 (since the desired markings on track number 100 only span the region from angular position 110d to angular position 110c). If each data element of data block 318 for track number 100 is a binary value, then the data elements where marks are to be made (corresponding to the tops of the letters “l”, “b”, and “L”) would have a value of “1”, while the remaining data elements where no marks are to be made would have a value of “0”.

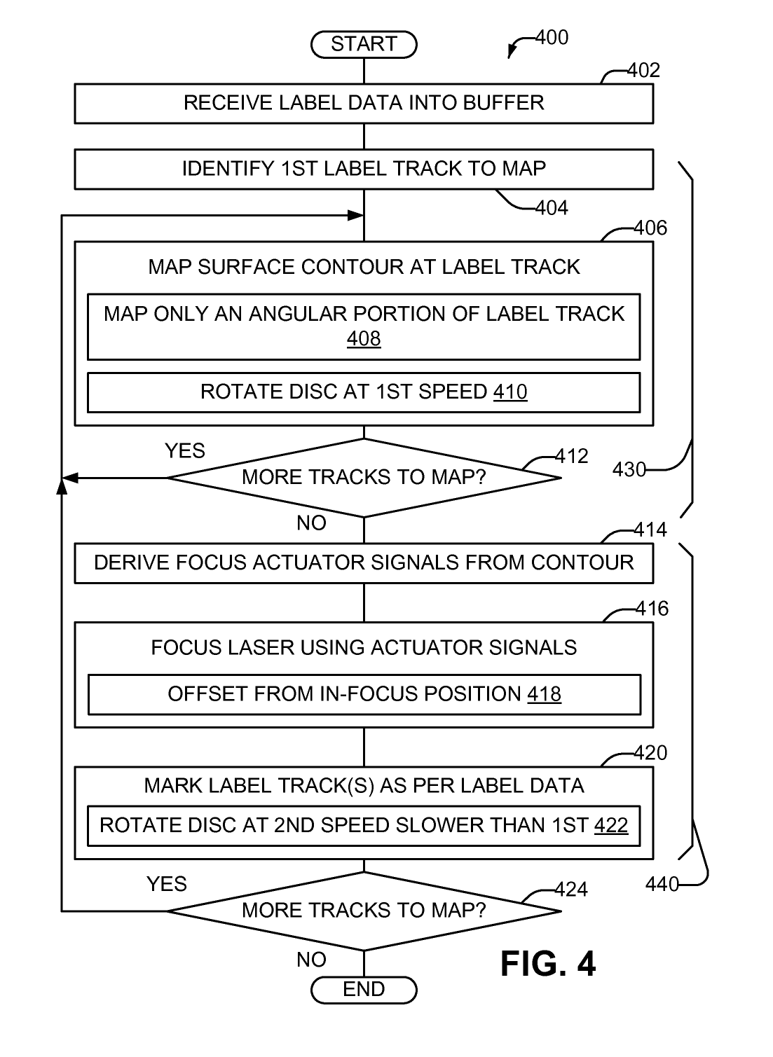

Considering now in greater detail one embodiment of a method of forming a visible label on an optical disc, and with reference to FIG. 4, the method 400 can be considered as having a mapping phase 430 and a marking phase 440. In some embodiments, the method may be implemented in the disc drive 200, where some or all of the steps are stored as instructions in memory, such as memory 260, and are computer-executable by CPU 254.

The method begins, at 402, by receiving label data 300 for a predetermined label track 112 of the disc 100 on which marks are to be made into a buffer 295 of a disc drive 200. In some embodiments, the label data 300 is received in sequential track order; for example, label tracks 112 from the inner radius to the outer radius. At 404, the label data 300 is analyzed to identify the first label track 112 that is to be mapped. The value of one or more of the data buffer pointers may identify the data packet 310 that is associated with the first label track 112 in the buffer 295, and that data packet 310 is then analyzed to determine the track number 312 to which the data packet 310 pertains. The track number 312 denotes the first track 112 that is to be mapped.

At 406, the surface contour of the disc 100 is mapped only at the particular label track 112 that is identified by the corresponding track number 312. The mapping involves operating the laser 230 and the focus actuator 212 to characterize the surface contour. The mapping produces surface contour data 292 for the track 112. In some embodiments, the mapping operation 406 includes determining, for at least some angular positions of only the label track 112, a corresponding position of the focus actuator 212 that focuses the laser on the label track 112. This may include determining the in-focus position of the laser for the label track 112.

The surface contour data 292 can be processed, reduced, and stored in a variety of ways. One embodiment in which surface contour data is represented as Fourier series gain coefficients is described in U.S. Pat. No. 7,177,246, “Optical Disk Drive Focusing Apparatus Using SUM Signal”, by Hanks et al., and assigned to the assignee of the present invention.

In some embodiments of the mapping operation 406, the disk surface is mapped at 408 only for a predetermined angular portion of the track 112. The spoke number 314 and the data length 316 of the data packet 310 may be analyzed in order to identify the angular portion that is to be mapped. The angular portion that is to be mapped corresponds to the angular positions on the track 112 to which the data 318 of the data packet 310 corresponds. The spoke number 314 indicates a starting angular position, and the angular span of the data block 318 can be determined using the data length 316. In some embodiments, mapping only the portion of the track 112 to which the data applies may result in a time reduction for the mapping operation 406 compared to the time expended to map the entire track 112. This time reduction may offset the additional time expended in the analysis of the spoke number 314 and data length 316 in order to determine the angular portion to be mapped.

In some embodiments of the mapping operation 406, the disc is rotated at 410 at a first speed during the mapping operation for the track 112, where the first speed is faster than a second speed at which the disc is rotated when marking the track 112.

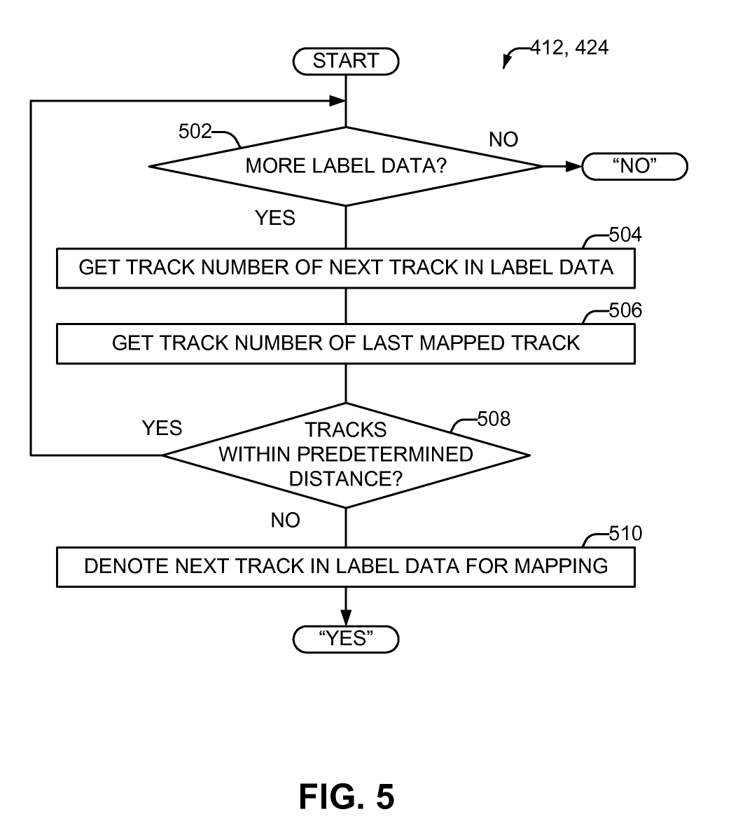

At 412, it is determined whether there are more label tracks 112 to be mapped. In one embodiment, as understood with reference to FIG. 5, at 502 it is ascertained whether more, as-yet unanalyzed, label data 300 exists in the data buffer 295. Typically this can be ascertained from the value of one or more of the data buffer pointers, as label data 300 for additional tracks may be received into the data buffer 295 during the mapping phase 430. If no unanalyzed label data 300 exists in the data buffer 295 (“No” branch of 502), however, the mapping phase 430 is complete and the method begins the marking phase at 414. By processing all the label data 300 in the data buffer 295 before marking any of the mapped tracks 112, settling time delays that may occur as a result of, for example, changing the disk rotation speed between the mapping and marking operations can be minimized.

If unanalyzed label data 300 does exist in the data buffer 295 (“Yes” branch of 502), the data packet 310 that is associated with the next label track 112 in the label data 300 is analyzed to determine the next track number 312 to which the data packet 310 pertains at 504. At 506, the track number of the last track at which the disc surface contour was mapped is obtained. At 508, it is determined whether the next track number 312, and the track number of the last track at which the disc surface contour was mapped, are within a predetermined radial distance. In embodiments which map the surface contour of every track 112 on which marks are to be made, the predetermined radial distance is zero. However, in embodiments where the surface contour mapping of the last mapped track can be used for marking other tracks within a predetermined radial distance of the last mapped track, the predetermined radial distance will be non-zero. If the next track and the last mapped track are within the predetermined distance (“Yes” branch of 508), the next track will not be mapped, the data buffer pointers are adjusted, and the method branches to 502 to determine whether additional as-yet unanalyzed label data 300 exists in the data buffer 295. If the next track and the last mapped track are not within the predetermined distance (“No” branch of 508), then at 510 the next track is denoted for mapping, and the method branches to step 406.

To illustrate, consider exemplary image 130 (FIG. 1) that occupies all of the label tracks 112 numbered from 200 to 300, and therefore marks are to be made on all of tracks 200-300. If the predetermined radial distance is zero, the disc surface contour will be mapped for each of tracks 200-300, for a total of 101 mapping operations. However, if the predetermined radial distance corresponds, for example, to a span of 33 tracks, then the surface contour would be mapped only for track 200 (the innermost track of image 130), track 234, and track 268; a total of 3 mapping operations. This would provide a significant time reduction for the mapping phase.

It is noted that, at the conclusion of the mapping phase 430, the surface contour of the disc 100 has not been mapped at other tracks 112 that do not correspond to any of the received data packets 310.

After completion of the mapping phase 430, the method switches to the marking phase 440 for the label track(s) 112 that have corresponding data 318 to be marked. At least some of these tracks will have been mapped during the mapping phase 430. Steps 414, 416, and 420 may be performed for a first track 112 to be marked, a second track 112 to be marked, and so on until all tracks 112 on which marks are to be made have been marked. At 414, signals to be applied to the focus actuator 212 during the marking operation for a label track 112 to be marked are derived using the surface contour data 292. At 416, the laser 230 is positioned adjacent to, and focused onto, a label track 112 to be marked, using the derived focus actuator signals. In some embodiments, focusing the laser at 416 includes offsetting at 418 the laser beam 214 a predetermined distance, such as the focus offset distance 225, from an in-focus position on the label track 112 so as to enlarge the markings formed on the label track 112 by the laser beam 214 to a predetermined size.

At 420, while the laser 230 is being focused on the track 112, and in sync with the rotation of the disc 110, the laser 230 marks the locations 114 on the track 112 that are indicated by the data block 318 of the data packet 310 that corresponds to that track 112. As the disc 110 is rotated and locations 114 on the track 112 are marked, the laser focus actuator 212 may be periodically updated using surface contour data 292 to compensate for any angular variations in the disc surface contour. In some embodiments, at 422, the disc is rotated at a second speed during the marking operation 420 for the track 112, where the second speed is slower than the first speed at which the disc is rotated when mapping at or near that track 112.

One embodiment of deriving the focus actuator signals using the surface contour, and focusing the laser on the label track in sync with the disc rotation, is described in U.S. Pat. No. 7,177,246, “Optical Disk Drive Focusing Apparatus Using SUM Signal”, by Hanks et al., and assigned to the assignee of the present invention.

At 424, it is determined whether there are more label tracks 112 to be mapped. Label data 300 for other tracks can typically be received into the data buffer 295 during the marking phase 440. In one embodiment, the determination at 424 is performed according to the method of FIG. 5, and in a similar manner as has been described with reference to the determination at 412. If there are more label tracks 112 to be mapped (“Yes” branch of 424), the method branches to step 404 to begin the mapping phase 430 again. If there are no more label tracks 112 to be mapped (“No” branch of 424), then the method 400 has been completed.

From the foregoing it will be appreciated that the optical disc drive and methods provided by the present invention represent a significant advance in the art. Although several specific embodiments of the invention have been described and illustrated, the invention is not limited to the specific methods, forms, or arrangements of parts so described and illustrated. For example, the invention is not limited to an optical disc drive. Rather, the invention also applies to other devices which mark optically-labelable material having a varying surface contour, regardless whether the motion between the labelable material and the source of electromagnetic energy is rotational or translational. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Unless otherwise specified, steps of a method claim need not be performed in the order specified. For example, in some embodiments, rotating 410 the disc at the first speed may be performed prior to mapping 406 the surface contour at the label track, and/or rotating 4220 the disc at the second speed may be performed prior to marking 420 the label track(s) as per the label data. The invention is not limited to the above-described implementations, but instead is defined by the appended claims in light of their full scope of equivalents. Where the claims recite “a” or “a first” element of the equivalent thereof, such claims should be understood to include incorporation of one or more such elements, neither requiring nor excluding two or more such elements. Terms of orientation and relative position (such as “top”, “bottom”, “side”, and the like) are not intended to require a particular orientation of embodiments of the present invention, or of any element or assembly of embodiments of the present invention, and are used only for convenience of illustration and description.

What is claimed is:

1. A method of forming a visible label on an optical disc, comprising:
receiving, into a buffer of a disc drive, label data for a label track of the disc;
analyzing the label data to identify the label track;
mapping a surface contour of the disc only near the label track;
deriving, using the surface contour, focus actuator signals for the label track; and
marking, with a laser of the disc drive, the label track according to the label data while focusing the laser on the label track using the focus actuator signals.

2. The method of claim 1, wherein the surface contour is not mapped at other label tracks that do not correspond to the label data.

3. The method of claim 1, wherein the label data is for a plurality of label tracks located within a predetermined radial distance on the disc, wherein the mapping includes mapping the surface contour for only one of the label tracks within the predetermined radial distance, and wherein the marking includes marking all of the label tracks within the predetermined radial distance.

4. The method of claim 1, wherein the label data in the buffer is for a plurality of label tracks, and wherein the mapping is performed for all of the plurality of label tracks before the marking is performed for any of the plurality of label tracks.

5. The method of claim 1, further comprising:
during the marking, receiving into the buffer additional label data for additional label tracks; and
after the marking, repeating the analyzing, mapping, deriving, and marking for the additional label tracks.

6. The method of claim 1, wherein the disc is rotated at a first speed when mapping the label track, and at a second speed slower than the first speed when marking the label track.

7. The method of claim 1, wherein the label data is for labeling only a predetermined angular portion of the label track,
wherein the analyzing includes analyzing the label data to identify the angular portion, and
wherein the mapping includes mapping the surface contour only at the angular portion of the label track.

8. The method of claim 1, wherein mapping the surface contour includes determining, for at least some angular positions of only the label track, a corresponding position of a focus actuator that focuses the laser on the label track.

9. An optical disc drive for forming a visible label on an optical disc, comprising:
a data buffer configured to receive from an external source label data for a label track of the disc; and
a controller configured to
analyze the label data to identify the label track,
operate a laser and a focus actuator to characterize a surface contour of the disc only near the label track, and
mark the label track with the laser according to the label data while applying signals derived from the surface contour to the focus actuator so as to focus the laser for the label track.

10. The optical disc drive of claim 9, wherein the label data in the buffer is for a plurality of label tracks, and wherein the surface contour is characterized for all of the plurality of tracks before any of the plurality of label tracks are marked.

11. The optical disc drive of claim 9,
wherein the data buffer is further configured to receive additional label data for additional label tracks when the controller is marking the label track with the laser, and
wherein the controller is further configured, after the controller has finished marking the label track with the laser, to analyze the additional label data, characterize the surface contour of the disc only at the additional label tracks, and mark the additional label tracks.

12. The optical disc drive of claim 9, wherein the controller is further configured to rotate the disc at a first speed when characterizing the surface contour of the disc at the label track, and at a second speed slower than the first speed when marking the label track.

13. A method of forming a visible label on an optical disc, comprising:
receiving, into a buffer of a disc drive, label data for marking a plurality of label tracks of the disc;
analyzing the label data to identify the label tracks to be marked;
mapping a surface contour of the disc only at some or all of the label tracks to be marked;
deriving, using the surface contour, focus actuator signals for all of the label tracks to be marked; and
marking, with a laser of the disc drive, all of the label tracks according to the corresponding label data for each label track while focusing the laser on each label track using the corresponding focus actuator signals for each label track.

14. The method of claim 13, wherein the mapping includes mapping the surface contour for only one label track of a set of label tracks that are located within a predetermined radial distance on the disc.

15. The method of claim 13, wherein the surface contour is not mapped at other label tracks that do not correspond to the label data.
